(19) United States
(12) Patent Application Publication
(10) Pub. No.: US 2006/0019404 A1
(43) Pub. Date: Jan. 26, 2006

(54) Quantitative assay with extended dynamic range

(76) Inventors: Joel M. Blatt, Mountain View, CA (US); Michael P. Allen, Los Altos, CA (US); Diem Quynh Le, San Jose, CA (US); Paul J. Patel, Sunnyvale, CA (US); Patrick Sexton, Poway, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/061,096

(22) Filed: Feb. 18, 2005

Related U.S. Application Data
(63) Continuation of application No. 09/306,475, filed on May 6, 1999, now abandoned.
(60) Provisional application No. 60/084,443, filed on May 6, 1998.

(51) Int. Cl. G01N 21/77

(52) U.S. Cl. 436/169

(57) ABSTRACT

An efficient design for an expanded dynamic range in a lateral flow one step assay for the detection of an analyte in a biological sample is disclosed. The device comprises a multiple strip design, each constructed of four zones; a sample receiving zone, a sample treatment zone, a labeling zone, and a capture zone. The sample containing analyte is accepted in the sample receiving zone in the form of blood, serum, plasma, or urine. It is then carried into the sample treatment zone where it is rendered compatible with the chemistries of the assay strip. The treated sample then flows into the labeling zone where it interacts with visible particles that are coupled to analyte specific binding proteins. The flow continues, carrying the labeled analyte into the capture zone where it is immobilized in specific regions with analyte specific binding proteins. Excess flow is absorbed in an absorbent zone that is in contact with the capture zone. A positive result is interpreted by detection of the visible particles in the specified regions of the capture zone.

### RELATED APPLICATION

The present application repeats a substantial portion of prior application Ser. No. 08/455,236 entitled “Disposable Electronic Assay Device” filed May 31, 1995 by Michael P. Allen, now U.S. Pat. No. 5,580,794, which is a continuation of application Ser. No. 08/111,347 entitled “Disposable Electronic Assay Device” filed Aug. 24, 1993 by Michael P. Allen, now abandoned and prior application Ser. No. 08/657,894 entitled “Electronic Assay Device and Method” filed Jun. 6, 1996 by Michael P. Allen, Joel M. Blatt, and Joseph T. Windamas which is a continuation-in-part of application Ser. No. 08/455,236 entitled “Disposable Electronic Assay Device” filed May 31, 1995 by Michael P. Allen, now U.S. Pat. No. 5,580,794, which is a continuation of application Ser. No. 08/111,347 entitled “Disposable Electronic Assay Device” filed Aug. 24, 1993 by Michael P. Allen and now abandoned. The present application adds and claims additional disclosure not presented in the prior applications. Since the resent application names an inventor named in the prior applications, it constitutes a continuation-in-part of the prior applications.

The present application also repeats a substantial portion of prior application Ser. No. 08/512,844 entitled “Dry Reagent Particle Assay and Device Having Multiple Test Zones and Method Therefor” filed Aug. 9, 1995 by Joel M. Blatt and Michael P. Allen, and prior application Ser. No. 08/703,479 entitled “device and Method for Preventing Assay Interference” filed Aug. 27, 1996 by Joel M. Blatt, Wilma M. Mangan, Paul J. Patel and Victor A. Manneh.

The subject matter of this application is related to a disposable single-use digital electronic instrument that is entirely self-contained, including all chemistry reagents, as disclosed in U.S. application Ser. No. 08/642,228 entitled “Method and Device for Measuring Reflected Optical Radiation” filed Apr. 30, 1996 by Raymond T. Hebert, Joel M. Blatt, and Joseph T. Widunas. The above applications have the same assignee as the present invention and is incorporated herein by reference in its entirety.

### FIELD OF THE INVENTION

Optimal assay performance over an extended analyte dynamic range is assured by switching between test zones with progressively decreasing sensitivity to analyte concentration. As the upper end of optimal performance for a given zone is reached, the result is obtained from the next less sensitive zone.

### BACKGROUND OF THE INVENTION

All existing non-isotopic quantitative hCG tests require dilution of the sample when the analytical result is out of range of the basic assay chemistry. Biological samples can range from 0 to over 200,000 mIU/mL, depending on the stage of pregnancy, according to the following table (extracted from the package insert for the Abbott AxSYM® Total β-hCG test; and partially from Hussa¹):
Hussa R O. The Clinical Marker hCG. Westport, Conn: Prager Publishers. 1987: 137-50.

| Weeks Post LMP | Approximate hCG | Recommended |
|---|---|---|
| (Last Menstrual Period) | Range (mIU/mL) | Dilution Protocol |
| 3-4 Weeks | 9-130 | None |
| 4-5 Weeks | 75-2,500 | None, 1:10 |
| 5-6 Weeks | 850-20,800 | 1:10, 1:200 |
| 6-7 Weeks | 4,000-100,200 | 1:10, 1:200 |
| 7-12 Weeks | 11,500-289,000 | 1:200 |
| 12-16 Weeks | 18,300-137,000 | 1:200 |
| 16-29 Weeks | 1,400-53,000 | 1:10, 1:200 |
| (2^{nd} Trimester) | | |
| 29-41 Weeks | 940-50,000 | 1:10, 1:200 |
| (3^{rd} Trimester) | | |

In cases of trophoblastic disease or ectopic pregnancy, the levels of hCG may be abnormally high or low relative to the values shown above. Note that the Abbott protocol calls for dilution of the sample in almost all cases except for the earliest times where the level of hCG is still relatively low. The dynamic range for the Abbott assay (undiluted samples) is up to 1000 mIU/mL, with a lower detection limit (sensitivity) of 2.0 mIU/mL (results lower than 5 mIU/mL are reported as “negative”). Samples over 1000 mIU/mL must be diluted. The performance characteristics of the IMx® Total β-hCG test (Abbott), the OPUS® Total β-hCG test (Behring/Dade), the OPUS® hCG test (Behring/Dade; upper limit=500 mIU/mL), the Amerlite® HCG-60 Assay (Kodak; sensitivity=1 mIU/mL), the Enzymun-Test® hCG (Boehringer Mannheim; upper limit=600 mIU/mL), and the Stratus® βhCG Fluorometric Enzyme Immunoassay (Dade International) are similar (except as noted). Only the Kodak Amerlex-M® Extended Range HCG RIA Kit claims a dynamic range from 0 to 300,000 mIU/mL without sample dilution. However, unlike the non-isotopic assays above, it employs ¹²⁵I-labeled hCG (with its attendant hazards) in a competitive radioimmunoassay format.

### SUMMARY OF THE INVENTION

An efficient design for an expanded dynamic range in a lateral flow one step assay for the detection of an analyte in a biological sample is disclosed. The device comprises a multiple strip design, each constructed of four zones; a sample receiving zone, a sample treatment zone, a labeling zone, and a capture zone. The sample containing analyte is accepted in the sample receiving zone in the form of blood, serum, plasma, or urine. It is then carried into the sample treatment zone where it is rendered compatible with the chemistries of the assay strip. The treated sample then flows into the labeling zone where it interacts with visible particles that are coupled to analyte specific binding proteins. The flow continues, carrying the labeled analyte into the capture zone where it is immobilized in specific regions with analyte specific binding proteins. Excess flow is absorbed in an absorbent zone that is in contact with the capture zone. A positive result is interpreted by detection of the visible particles in the specified regions of the capture zone.

### BRIEF DESCRIPTION OF THE DRAWINGS

In the drawings which comprise a portion of this disclosure:

FIG. 1 is an exploded cross-sectional side view of one configuration of the sample processing components for single analyte testing;

FIG. 2 is an isometric view of the embodiment of the disposable device of this invention for two analyte testing;

FIG. 3 is a schematic view of the device of FIG. 2, showing one configuration of the electronic and sample processing components for two analyte testing;

FIG. 4 is an exploded cross-sectional side view of one configuration of the sample processing components for two analyte testing in the embodiment of FIGS. 4 and 5;

FIG. 5 shows a top view of a dry reagent configuration that can be used for general chemistry assays for two analytes;

FIG. 6 is an exploded view of a lengthwise cross section of the reagent strip shown in FIG. 5;

FIG. 7 shows a top surface view of an embodiment having a typical structure with a sample filtration/blood separation device;

FIG. 8 shows an exploded lengthwise cross section of the embodiment of FIG. 7; and FIG. 9 shows a top surface view of an embodiment of a qualitative and quantitative assay for HCG in urine or serum or whole-blood.

### DETAILED DESCRIPTION OF THE INVENTION

Optimal assay performance over an extended analyte dynamic range is assured by switching between test zones with progressively decreasing sensitivity to analyte concentration. As the upper end of optimal performance for a given zone is reached, the result is obtained from the next less sensitive zone. From a practical point of view, this transition is determined from the reflectance values for each zone. The limit for optimal reflectance measurement for any zone is determined by the point at which further decrease in reflectance (increase in analyte concentration) results in an unacceptable increase in imprecision (CV). This reflectance (R) value is typically about 0.10 (10% R). The following figure illustrates the typical dependence of CV on % R. The error calculation in this figure assumes that the analyte concentration result is proportional to K/S, defined as

$$\frac{{( 1 - R )}^{2}}{2 R} ,$$

which is approximately true for sandwich immunoassays, but is not true for competitive systems. It is thus not a representative figure for all immunoassays, but is used to illustrate the point that error typically increases at the extremes of the measurement range.

[image]

The reflectance value that is used to determine this imprecision threshold in Metrika's DRx™ is programmable and depends on the performance of the particular zone in question. It will typically vary between 5 and 20 % R. The ideal dynamic range for an individual test zone is about 20-fold in analyte concentration. Therefor, Metrika's assay is being set up as follows:

| Zone | hCG range (mIU/mL) |
|---|---|
| 2 | 0-100 |
| 1 | 100-1,000 |
| 4 | 1,000-10,000 |
| 3 | 10,000-250,000 |

In this manner, total imprecision is limited to less than 15% CV over a wide dynamic range (0 to >250,000) while maintaining high sensitivity (lower detection limit=2 mIU/mL).

hCG Assay Layout:

[image]

The chemistry is self-contained within the instrument and dry formulated on a solid matrix (i.e. membrane) where reflectance is used or lyophilized and deposited in a reaction compartment or spotted and dried in a reaction compartment where transmission is used or present on an electrode where the chemistry produces a change in electrical current or pH. The chemistry operates in response to the analyte to produce a color change within the chemistry matrix or in a fluid defined by the sample (i.e. plasma) and reconstituted reagents or the chemistry will produce a change in electrical current (i.e. produce or consume electrons) or cause a pH change that can easily be detected. This type of chemistry is common in home glucose instruments that contain chemistry reagents impregnated in a reagent strip.

Substantially all types of common clinical assays can be carried out on this system. Assays that can be done include, but are not limited to, general chemistry assays for analytes such as glucose, cholesterol, HDL cholesterol, LDL cholesterol, triglycerides, and BUNS; and immunoassays for therapeutic drugs like theophylline, digoxin, and phenobarbital, drugs of abuse such as THC, morphine, cocaine, amphetamine, methamphetamine, PCP, and LSD; and antibodies such as HIV antibody, and proteins like C-reactive protein and enzymes like alkaline phosphatase, CKMB or Pro Thrombin.

Single or multiple assays can be done at one time. For example, a single assay can be done measuring cholesterol or one device can be set up to measure both total and HDL cholesterol from a single sample. One test device can be set up to measure one, two, three, or more analytes at one time.

Qualitative and quantitative assays can be done. For example, a pregnancy test or a drugs of abuse assay need not be quantitative and the display may read POS or NEG. Other tests like theophylline, and digoxin, or cholesterol and HDL cholesterol require quantitative results. In this system it is possible to display both a quantitative and qualitative result. For example, if a cholesterol value is 280 mg/dl, the display may read 280 mg/dl HIGH RISK-SEE YOUR DOCTOR.

This device of this invention is ideal for on site testing in remote locations throughout the world in health fairs, occupational health settings, physician offices, and in the home. The device can include automatic reagent handling (sample filtration, component separation, blood separation or the like), automatic sample measurement, automatic reagent deliver, and on board controls such that non-technical users can operate the test easily without prior training. Also since the device uses a digital display (like a calculator) there is no need for visual interpretation of color quality or intensity or visual reading of a signal migration distance. Thus, user errors will be significantly reduced using this disposable electronic device. The device can be used for qualitative and quantitative measurement of many analytes of clinical interest including, but not limited to cholesterol, HDL and cholesterol, triglyceride, glucose, qualitative HCG (pregnancy), quantitative HCG (ectopic pregnancy), C-reactive protein (CRP), tumor markers, HIV antibodies, enzymes, drugs of abuse, and therapeutic drugs using both general chemistry and immunoassay methods. Both endpoint and reaction rate type assays can be accomplished using this device.

The reagent strip 10 has an electrode pair 12 mounted thereon between a sample application zone 14 and a reagent zone 16 to detect the presence and movement of sample liquid on the reagent strip. Presence of sample liquid bridging the electrode pair reduces the resistance across the electrodes, signaling the presence of a conductor (sample liquid) therebetween. LED 18 is positioned between the detectors 20 and 22.

FIG. 1 is an exploded cross-sectional side view of one configuration of the sample processing components for single analyte testing. The reagent strip 10 rests on a lower plate of housing 8 supporting the electrodes 12 and 26, LED 18 and detectors 20 and 22. A separation device 36 rests on the input end of strip 10. The strip 10 includes a plurality of zones 38, 40 and 42, the functions of which will be described in detail hereinafter.

The chemical reagents are dry formulated on the reagent strip 20 which can be any convenient bibulous material including, but not limited to, paper such as Whatman 1C, 2C, 31ET or S&S 903C, 470, 604 or the like; synthetic membranes such as Millipore IMMOBILON, Pall nylon, S&S nitrocellulose, cellulose acetate, regenerated cellulose, Gelman VERSAPORE or the like. The reagent strip 10 can also be made of any convenient bibulous material including porous plastics such as polyethylene and polypropylene, examples of which are made by Porex Technologies Corp., or synthetic or natural mesh screens, examples of which are made by Tetko. The sample filtration and blood separation components 26 can be constructed using synthetic membranes, fibrous depth filters such as glass fiber, plastic fiber, metal fiber, cellulose fiber or the like or any combination or filters and membranes.

The housing for the device can be made of any convenient material including, but not limited to, thermoplastics such as polyethylene, DELRIN, ABAS and polystyrene.

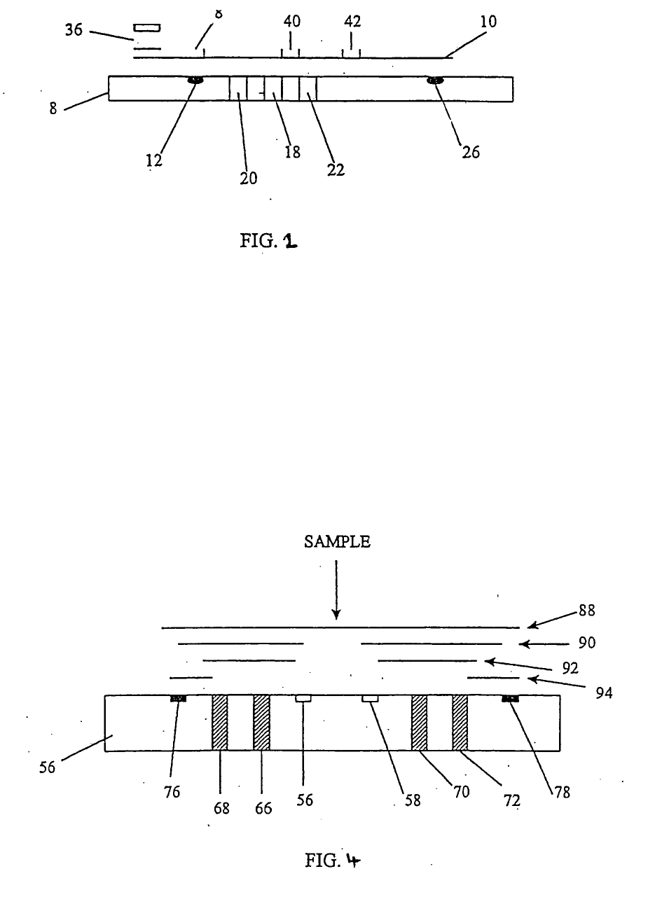

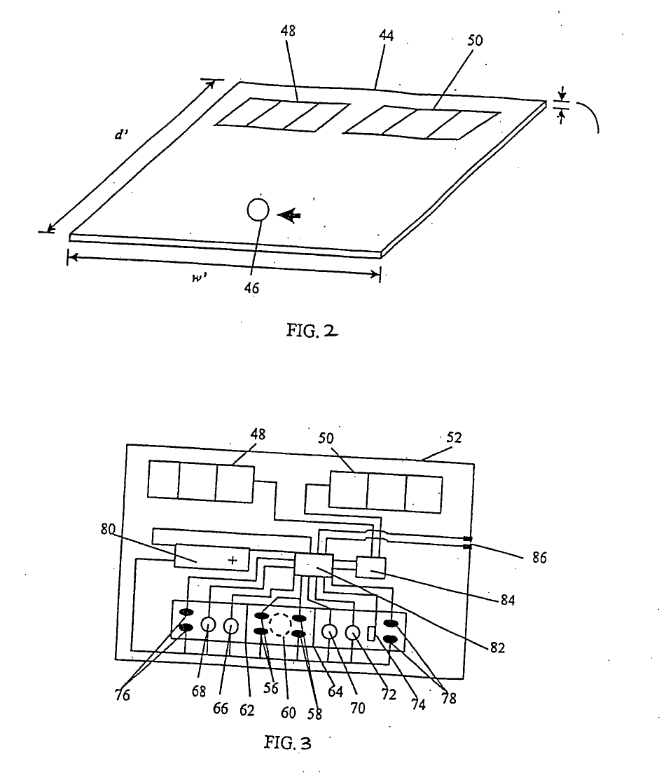

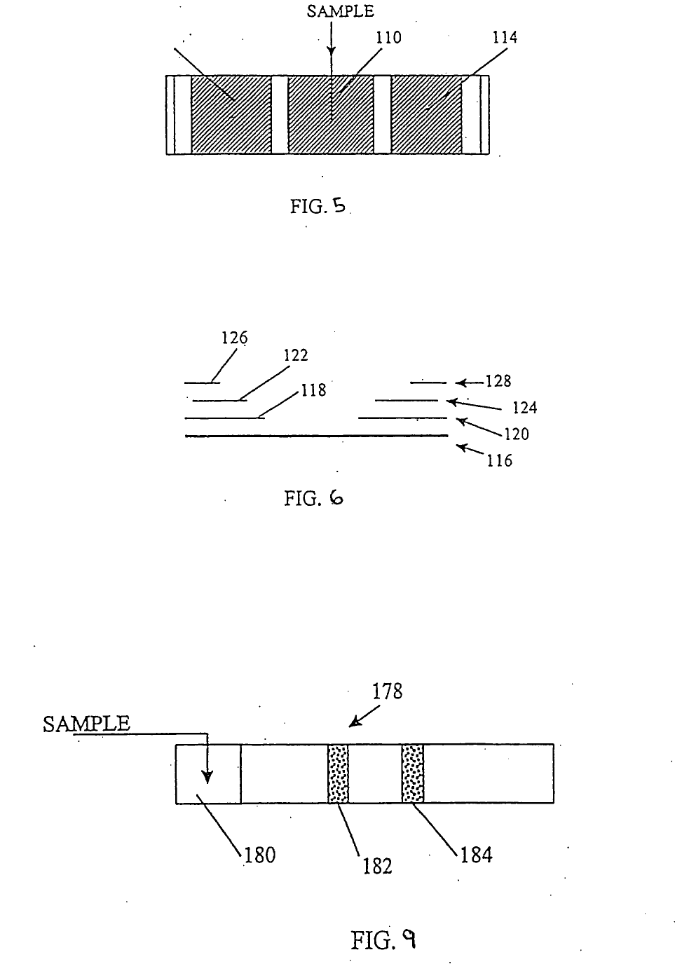

FIG. 2 is an isometric view of the embodiment of the disposable device of this invention for two analyte testing. FIG. 3 is a schematic view of the device of FIG. 2, showing one configuration of the electronic and sample processing components for two analyte testing. FIG. 4 is an exploded cross-sectional side view of one configuration of the sample processing components for two analyte testing in the embodiment of FIGS. 4 and 5. The device 44 has a sample receptor 46 and visual readout displays 48 and 50 such as liquid crystal displays.

FIG. 4 is an exploded cross-sectional side view of one configuration of the sample processing components for two. analyte testing of the embodiment shown in FIGS. 4 and 5. The reagent strips rests on a lower plate of housing 54 supporting the electrodes 76, 56, 58, and 78 and detectors 68 and 72. The sample transport matrix 88, separation membrane 90, reaction membrane 92 and adhesive layer 94 secures together layers 88, 90, and 92.

FIGS. 9 and 10 show an assay strip that measures two general chemistry analytes at one time from one sample. The sample is applied between the two reaction surfaces. The multiple assay example shown in the FIGS. 9 and 10 can be for HDL and total cholesterol, and LDL lipoproteins will have to be removed prior to measurement in the case of the HDL assay.

FIG. 5 shows a top view of a dry reagent configuration that can be used for general chemistry assays for two analytes, and FIG. 6 is an exploded view of a lengthwise cross section of the reagent strip shown in FIG. 5. Referring to FIG. 5, the two test strip has a sample application zone 110, HDL reaction zone 112 and cholesterol reaction zone 114. Referring to FIG. 6, the strip is constructed with a series of layers, the sample transport matrix 116, separation membranes 118 and 120, reaction membranes 122 and 124 and adhesive layers 126 and 128.

FIGS. 11 and 12 show various embodiments of immunoassay strip configurations that can be used in the disposable instrument here described. The immunoassay configurations presented here can measure small molecules (haptens) or large molecules (usually proteins). The immunoassays can be set up to be either qualitative in the case of HCG (pregnancy), drugs of abuse, and infectious disease or quantitative in the case of theophylline, digoxin, quantitative HCG (etopic pregnancy), C-reactive protein, and CKMB.

Since the subject device is designed for use on-site and in the home, the device must have sample filtration and separation. Whole-blood from a finger stick will be used and since the assay chemistry can operate only on serum or plasma, the red cells must be substantially removed by the device prior to chemical analysis.

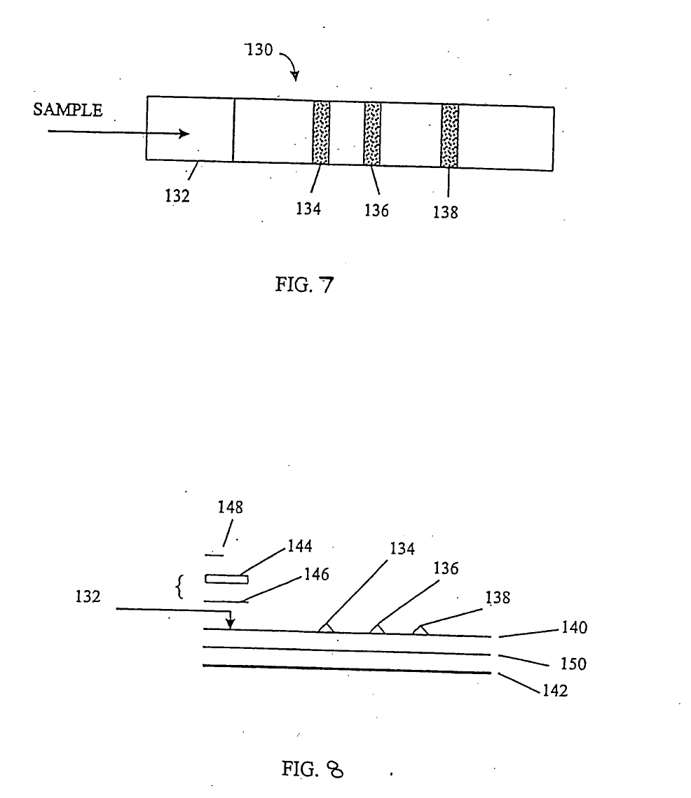

FIG. 7 shows a top surface view of an embodiment having a typical structure with a sample filtration/blood separation device, and FIG. 8 shows an exploded lengthwise cross section of the embodiment of FIG. 7. The overall length of the strip can be anywhere from 3 cm to 20 cm (most likely 4 cm to 10 cm) and the width can be 0.2 cm to 1.5 cm (most likely 0.3 cm to 0.7 cm). The strip shown in FIG. 7 is preferable 5 cm long and 0.5 cm wide. Although the assay strip can contain any number of zones, there are four zones shown in FIG. 7 along the length of the assay strip each containing assay reagents diffusively or ono-diffusively bound. The assay strip can contain two, three, four, five or more zones (whatever is necessary to carry out the chemistry). The strip can be one continuous section or be composed of one, two, three or more sections. Each zone may be a separate bibulous material all in fluid communication or one or more zones can be a common material with other zones being separate materials.

Zone 132 on the strip 130 is located at or slightly downstream from the site of sample application and zone 134 can be directly adjacent or separated by a bibulous spacer in fluid communication downstream from zone 132. Zone 136 can be directly adjacent to zone 134 or be separated in fluid communication downstream from zones 132 and 134, and zone 138 can be directly adjacent to zone 136 or separated in fluid communication downstream from zones 132, 134, and 136. All zones are in fluid communication with each other and with the sample application area. The sample application area can be the same area as zone 132 or the sample application area can be a separate area directly adjacent and upstream from zone 132. Zones 132, 134, 136, and 138 can be 0.05 cm to 1.5 cm in length (most usually 0.1 cm to 1.0 cm in length).

The assay strip including each of the four zones can be composed of the same or different bibulous materials. Examples of materials which can be used include but are not limited to: cellulose papers such as Whatman 1C, 2C, 4C, 31ET, S&S 903C, GB002; membranes such as S&S nitrocellulose, cellulose acetate, regenerated cellulose at pore sizes from 1 μ to 20 μ, Pall nylon at pore sizes of 1 μ to 20 μ, Gelman ULTRABIND, Millipore IMMOBILON; composite papers or membranes made from mixtures of glass fiber, plastic or metal fiber, cellulose, cellulose acetate, nitrocellulose, regenerated cellulose; or synthetic or natural mesh or fabric made from cotton, cellulose, polyethylene, polyester or nylon.

Zones 132, 134, 136 and 138 can contain reagents diffusively or non-diffusively bound including, but not limited to, antibodies, antigens, enzymes, substrates, small molecules, proteins, recombinant proteins, viral or bacterial lysate, receptors, sugars, carbohydrates, polymers like PVA, and detergents.

The plastic backing 142 in FIG. 8 may or may not be necessary to provide structural support and if necessary can be on any convenient material that provides support for the assay matrix including cellulose acetate, polyester, vinyl or the like at thicknesses of 0.002 inch to 0.015 inch (most usually 0.005 inch to 0.010 inch thick), or synthetic or natural fabric or mesh. The adhesive 150 can be any double stick adhesive including 3M 415, 443, 9460 or the like.

The sample filtration/blood separation device is composed of one, two or several layers of depth filter 144 such as glass fiber, metal fiber, synthetic fiber, paper, or natural or synthetic fabric and a membrane 146 such as S&S cellulose acetate, nitrocellulose, regenerated cellulose at pore sizes from 0.2 μ to 7 μ, nucleopore or poretics polycarbonate at pore sizes of 0.2 μ to 5 μ. The blood separation device is designed to remove substantially all of the red cells from the blood sample, leaving plasma to operate in the assay. As shown in FIG. 8, the sample filtration is positioned immediately above and in fluid communication with strip zone 132. The fiber membrane can be 0.5 cm to 1 cm in length and are secured with adhesive as shown or are held in place by the instrument housing. The adhesive layers 148 and 150 can be any convenient adhesive including epoxy, hot melt glue, or the like or adhesive tape like that made by 3M Company.

FIG. 9 shows a top surface view of an embodiment of a qualitative and quantitative assay for HCG in urine or serum or whole-blood. Zone 180 of strip 178 contains a conjugate or polyclonal anticz-αHCG to colloidal gold. Zone 182 contains mouse anti-βHCG non-diffusively bound. Zone 184 contains anti-polycloncal HCG non-diffusively bound.

In this embodiment, the sample is applied through the sample filtration device to zone 180 where the α subunit of HCG in the sample binds to the polyclonal anti-HCG of the conjugate. The sample and conjugate move via wicking action and flows through zone 182 where the β subunit of HCG will bind to the antibody immobilized in this area, forming an antibody sandwich of HCG and thereby immobilizing the gold. This is a positive read assay where signal is concentrated in zone 182 in response to the presence of HCG in the sample. The more HCG in the sample will result in more color intensity in zone 182. The anti-polyclonal HCG in zone 184 will always bind the conjugate regardless of the presence or concentration of the HCG in the sample. This zone will serve as a positive high level control such that the instrument will make a comparison of the color intensity in zone 182 and 184, and based on a calibration, provide a positive or negative result or a numerical concentration in clinical units on the display.

### EXAMPLE 1

The sample receiving zone is prepared from Ahlstrom 1281 (Ahlstrom Filtration Inc., Mt. Holly Springs, Pa.) material. The material is saturated with a blood separating solution at 45 ul/cm2 containing 2.5 mg/ml rabbit anti-human red blood cells (Code 209-4139; Rockland Immunochemicals, Gilbertsville, Pa.) antibody diluted in acetylated bovine serum albumin (AcBSA). The membrane is frozen at −70° C. for at least one hour and then lyophilized in a Virtis Genesis (Virtis, Gardiner, N.Y.) overnight. The treated sample receiving zone is cut into 7.0×7.0 mm squares and stored at less than 5.0% relative humidity (RH) until assembly.

The sample treatment zone is prepared from Ahlstrom 1281 material. The material is treated with a sample treatment buffer at 45 ul/cm2. Sample treatment buffer is composed of 0.5M Sodium Perchlorate in 50 mM Tris buffer, 2.0 mg/ml non-specific Mouse IgG (P/N 9902; Intergen Company, Milford, Mass.), and 1.67 mg/ml heterophilic IgG block (Heteroblock P/N 70506; Omega Biologicals Inc., Bozeman, Mont.). The pad of Ahlstrom 1281 is frozen at −70° C. for at least one hour. The Ahlstrom material is lyophilized in the Virtis Genesis overnight. The sample treatment zone is then cut into 3.5×3.0 mm rectangles and stored at less than 5.0% RH until assembly.

To prepare the labeling beads, 0.50 ml of 0.36 um blue latex particles (P/N LC9786; Emerald Diagnostics Inc., Eugene, Oreg.) at 2.5% solids is combined with 0.50 ml Monoclonal Anti-hCG (clone #5008; OyMedix Biochemica, Kauniainen, Finland) antibody in 25 mM Tris buffer at 1.0 mg/ml. The solution is allowed to react passively on an orbital rotator at room temperature (RT) overnight. After centrifugation at 10000 rpm for 5 minutes, the supernatent is aspirated. The pellet is resuspended manually with highly polymerized bovine serum albumin (polyBSA) (P/N 99-012-5; Bayer Corporation, Kankakee, Ill.) solution (10 mg/ml). The particles are allowed to block for one hour at RT on an orbital rotator. After centrifugation at 10,000 rpm for 5 minutes, the supernatent is aspirated. The pellet is resuspended manually with polyBSA solution (10 mg/ml). The particles are allowed to block for one hour at RT on an orbital rotator. After centrifugation at 10,000 rpm for 5 minutes, the supernatant is aspirated. The pellet is resuspended manually with acetylated BSA solution (10 mg/ml) to a final particle concentration of 1.0% solids.

To prepare the labeling zone solution, the labeling beads are diluted to a concentration of 0.1% solids in 10 mg/ml AcBSA, prepared in 50 mM Tris buffer, pH 8.0, with 0.1% (w/v) NaN3. Sucrose in 50 mM Tris buffer is added to a final concentration of 2.0%. The resultant mixture is stirred and dispensed onto Whatman F075-14 (Whatman, Inc., Fairfield, N.J.) material at 60 ul/cm2. The material is frozen at −70° C. for at least one hour. Membranes are lyophilized in Virtis Genesis overnight. The label containing pads are cut into 3.5×3.0 mm rectangles and stored at less than 5.0% RH until assembly.

To prepare the capture zone membrane, nitrocellulose having a pore size of 8-12 um (Schleicher and Schuell, Keene, N.H.) is affixed to an XY-plotter table. An hCG capture band is dispensed in a 2.0 mm zone at the distal end of the nitrocellulose membrane using Monoclonal Anti-hCG antibody (Clone MC097; Scripps Laboratories, San Diego, Calif.) at 1.0 mg/ml. The solution is dispensed with an IVEK Digispense (IVEK Corporation, Springfield, Vt.) dispensing system. After air drying at 45° C., the membrane is placed into a tray containing blocking solution (10 mg/ml AcBSA) for 20 minutes at RT. The membrane is removed and blotted for 5 minutes. The membrane is air dried at 45° C. for 5 minutes, and then placed at less than 5.0% RH overnight. Processed capture membranes remain at less than 5.0% RH until assembly.

To assemble the device, a 3.0×7.0 mm strip of the capture zone membrane is affixed centrally on an adhesive opaque strip. The opaque backing is a 350×23 mm strip of ARCare mylar made adhesive with 3M 9502.

The pad containing visible label is affixed next to the capture zone pad with 0.5 mm overlap. The sample treatment zone pad is then placed next to the label containing pad with 0.5 mm overlap.

The device is provided with an absorbent, which is a 3.5×3.0 mm rectangle of Whatman 31ET (Whatman, Inc., Fairifeld, N.J.) membrane. It is placed distal to the capture membrane with 0.5 mm overlap.

The resultant test strip on the opaque backing is then placed membrane side down in the MP1 unit such that the sample treatment pad is overlapped by the sample receiving pad by 1.0 mm. The strip is aligned such that the label capturing zones on the capture membrane are visible through the optical apperature of the device. Finally, the top cover is placed together with the bottom casing such that the sample well is aligned over the sample receiving pad.

Biological samples including whole blood, plasma, serum, and urine were collected from healthy, asymptomatic donors. The specimens were analyzed on Dade Stratus® to determine endogenous hCG levels. Analyte was spiked into the specimens at varying concentrations and levels were confirmed on the Reference Quantitative Assay. Quantitative hCG values were assigned and the specimens were assayed as follows:

The device is placed flat on the benchtop and 75 ul of sample is applied to the sample receiving zone. The liquid is allowed to flow through the four zones of the assay strip and collect in the absorbent pad. If hCG is present in the sample at least 25 mIU/mL, a blue band in the capture region will appear. The intensity of the band is measured with a reflectance densitometer (Model #D19C; Gretag Color Control Systems, Regensdorf, Switzerland). Increasing values from the Gretag indicate increasing color intensity. Performance results are described in the following table:

| HCG Concentration (mIU/mL) | Gretag Reflectance (Zone 1) |
|---|---|
| 0 | 0.20 |
| 26 | 0.30 |
| 108 | 0.53 |
| 534 | 0.80 |

### EXAMPLE 2

In manner similar to Example 1, a dual zone device is prepared. The preparation of the Sample Receiving Zone, the Sample Treatment Zone, the Labeling Zone, and the assembly of the components is identical to that described in Example 1. The capture zone for the dual zone devices is prepared as follows:

Analagous to Example 1, an hCG capture band is dispensed in a 2.0 mm zone using Monoclonal Anti-hCG antibody at 1.0 mg/ml at the distal end of the nitrocellulose strip. Dispensed proximal to the first capture zone, another 2.0 mm zone of Polyclonal Anti-intact hCG antibody (Clone G-123-C, BioPacific, Emeryville, Calif.) is striped at 0.1 mg/ml. Both zones are dispensed with an IVEK Digispense dispensing system. After air drying at 45° C., the membrane is placed into a tray containing blocking solution (10 mg/ml AcBSA) for 20 minutes at RT. The membrane is removed and blotted for 5 minutes. The membrane is air dried at 45° C. for 5 minutes, and then placed at less than 5.0% RH overnight. Processed capture membranes remain at less than 5.0% RH until assembly.

Analagous to Example 1, samples are collected and assayed for the dual zone device. Reflectance measurements are recorded for both zones and described in the following table:

| HCG Concentration (mIU/mL) | Test Zone 1 | Test Zone 2 |
|---|---|---|
| 0 | 0.20 | |
| 26 | 0.30 | |
| 108 | 0.53 | 0.26 |
| 534 | 0.80 | 0.30 |
| 765 | | 0.34 |
| 1020 | | 0.37 |
| 1600 | | 0.43 |
| 4965 | | 0.54 |
| 7500 | | 0.64 |

### EXAMPLE 3

In a manner similar to Example 2, a three zone device is prepared. The preparation of the Sample Receiving Zone, the Labeling Zone, and the assembly of the components is identical to that described in Example 2. The sample treatment zone and the capture zone for the three zone device is prepared a follows:

Analagous to Example 1, the sample treatment zone is prepared from Ahlstrom 1281 material. The material is treated with a sample treatment buffer at 45 ul/cm2. Sample treatment buffer is composed of 0.5M Sodium Perchlorate in 50 mM Tris buffer, 2.0 mg/ml non-specific Mouse, and 1.67 mg/ml geteropilic IgG block. To the sample treatment buffer formulation, Polycloral Anti-hCG antibody (Clone 70XG35; Fitzgerald Industries International, Inc., Concord, Mass.) is added at 0.62 mg/ml. The pad of Ahlstrom 1281 is frozen at −70° C. for at least one hour. The Ahlstrom material is lyophilized in the Virtis Genesis overnight. The sample treatment zone is then cut into 3.5×3.0 mm rectangles and stored at less than 5.0% RH until assembly.

To prepare the capture zone membrane, nitrocellulose obtained from Schleicher and Schuell, having a pore size of 8-12 um, is affixed to an XY-plotter table. The first nitrocellulose strip is prepared as described in example 2. To a second strip of nitrocellulose membrane, an hCG capture band is dispensed in a 2.0 mm zone at the distal end of the membrane using Polyclonal Anti-hCG antibody (Clone 70XG35; Fitzgerald Industries International, Inc.) at 1.0 mg/ml. All solutions are dispensed with an IVEK Digispense dispensing system. After air drying at 45° C., the membranes are placed into a tray containing blocking solution (10 mg/ml AcBSA) for 20 minutes at RT. The membranes are removed and blotted for 5 minutes. The membranes are air dried at 45° C. for 5 minutes, and then placed at less than 5.0% RH overnight. Processed capture membranes remain at less than 5.0% RH until assembly.

Sample Collection and Assay Performance

Analagous to Example 2, samples are collected and assayed for the three zone device. Reflectance measurements are recorded for all zones and described in the following table:

| HCG | | | |
|---|---|---|---|
| Concentration (mIU/mL) | Test Zone 1 | Test Zone 2 | Test Zone 3 |
| 0 | 0.20 | | |
| 26 | 0.30 | | |
| 108 | 0.53 | 0.26 | |
| 534 | 0.80 | 0.30 | |
| 765 | | 0.34 | |
| 1020 | | 0.37 | |
| 1600 | | 0.43 | |
| 4965 | | 0.54 | 0.18 |
| 7500 | | 0.64 | 0.25 |
| 10000 | | | 0.36 |
| 37000 | | | 0.76 |
| 61000 | | | 0.90 |

### EXAMPLE 4

In a manner similar to Example 3, a four zone device is prepared. The preparation of the Sample Treatment Zone, Sample Receiving Zone, the Labeling Zone, and the assembly of the components is identical to that described in Example 3. The capture zone for the four zone device is prepared as follows:

To prepare the capture zone membrane, nitrocellulose obtained from Schleicher and Schuell, having a pore size of 8-12 um, is affixed to an XY-plotter table. The first nitrocellulose strip is prepared as described in example 2. To a second strip of nitrocellulose membrane, an hCG capture band is dispensed in a 2.0 mm zone at the distal end of the membrane using Polyclonal Anti-hCG antibody (Clone 70XG35; Fitzgerald) at 1.0 mg/ml. Dispensed proximal to the first capture zone, another 2.0 mm zone of Monoclonal Anti-beta hCG antibody (Clone MIH9834; Genzyme Diagnostics, San Carlos, Calif.) is striped at 1.0 mg/ml. All solutions are dispensed with an IVEK Digispense dispensing system. After air drying at 45° C., the membranes are placed into a tray containing blocking solution (10 mg/ml ACBSA) for 20 minutes at RT. The membranes are removed and blotted for 5 minutes. The membranes are air dried at 45° C. for 5 minutes, and then placed at less than 5.0% RH overnight. Processed capture membranes remain at less than 5.0% until assembly.

Analagous to Example 3, samples are collected and assayed for the four zone device. Reflectance measurements are recorded for all zones and described in the following table:

| HCG Concentration | Test | | | |
|---|---|---|---|---|
| (mIU/mL) | Zone 1 | Test Zone 2 | Test Zone 3 | Test Zone 4 |
| 0 | 0.20 | | | |
| 26 | 0.30 | | | |
| 108 | 0.53 | 0.26 | | |
| 534 | 0.80 | 0.30 | | |
| 765 | | 0.34 | | |
| 1020 | | 0.37 | | |
| 1600 | | 0.43 | | |
| 4965 | | 0.54 | 0.18 | |
| 7500 | | 0.64 | 0.25 | |
| 10000 | | | 0.36 | |
| 37000 | | | 0.76 | |
| 61000 | | | 0.90 | 0.26 |
| 85000 | | | | 0.57 |
| 134000 | | | | 0.77 |
| 241000 | | | | 0.98 |
| 301000 | | | | 1.06 |

What is claimed is:

1. An assay for an extended analyte dynamic range comprising a plurality of test zones and means for switching between test zones with progressively decreasing sensitivity to analyte concentration.
